(19) United States
(12) Patent Application Publication
(10) Pub. No.: US 2008/0244620 A1
(43) Pub. Date: Oct. 2, 2008

(54) Dynamic Communication Fabric Zoning

(76) Inventors: Brian James Cagno, Tucson, AZ (US); Gregg Steven Lucas, Tucson, AZ (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/691,731

(22) Filed: Mar. 27, 2007

(51) Int. Cl. G06F 3/00

(52) U.S. Cl. 719/326

(57) ABSTRACT

A mechanism is provided for dynamically zoning or rezoning serially attached SCSI expanders using an intelligent failover mechanism. The mechanism uses serially attached SCSI (SAS) zoning by zoning off one port of the SAS hard disk drive to the initiator that does not “own” the resource. The drive will appear to only one initiator as a result of the zoning. In the event of a failure on the “owning” initiator, the failover mechanism may change the zones, zoning off the failed initiator and including the drives in the zone(s) of the active initiator(s). By using zoning in this fashion, the zoning mechanism creates an active-passive SAS multiplexer with configurable and intelligent failover.

### BACKGROUND

1. Technical Field

The present application relates generally to an improved data processing system and method. More specifically, the present application is directed to dynamic serial attached small computer system interface fabric zoning enabling active passive connection to dual ported disk drives using intelligent failover mechanism.

2. Description of Related Art

A newly emerging server tier has started to be architected. This server tier involves creating truly redundant servers, two servers installed into a single system, both of which can control the entirety of the system singularly. The major advantage is fault tolerance; no single failure will prevent the system from functioning.

Many servers are already utilizing enterprise class serially attached small computer system interface (serially attached SCSI or SAS) hard disk drives, which are dual ported. In today's non-redundant servers, the two ports of the drive are connected to a single initiator. As the architecture moves to the redundant style, it is necessary for the two ports of the SAS hard disk drives to be connected to two initiators redundantly. Both initiators see both ports on the same SAS hard disk drive (HDD). Early system adopters may need to write/rewrite much of the low level operating system code to handle such dual ported architectures, because current code cannot handle the same resource seen by two initiators.

### SUMMARY

The illustrative embodiments described herein recognize the disadvantages of the prior art and provide a mechanism for dynamically zoning or rezoning serially attached SCSI expanders using an intelligent failover mechanism. The mechanism uses serially attached SCSI (SAS) zoning by zoning off one port of the SAS hard disk drive to the initiator that does not “own” the resource. The drive will appear to only one initiator as a result of the zoning. In the event of a failure on the “owning” initiator, the failover mechanism may change the zones, zoning off the failed initiator and including the drives in the zone(s) of the active initiator(s). By using zoning in this fashion, the zoning mechanism creates an active-passive SAS multiplexer with configurable and intelligent failover.

In one illustrative embodiment, a computer program product comprises a computer useable medium having a computer readable program. The computer readable program, when executed on a computing device, causes the computing device to zone a communication fabric comprising a plurality of initiators and a plurality of storage devices according to a default zone configuration to zone at least one of the plurality of initiators to at least one subset of the plurality of storage devices. The computer readable program further causes the computing device to perform a health check and responsive to an initiator failing the health check, rezone the communication fabric.

In one exemplary embodiment, the default zone configuration zones a first subset of storage devices to a first initiator and zones a second subset of storage devices to a second initiator. In a further exemplary embodiment, the first initiator fails the health check and rezoning the communication fabric comprises zoning the first subset of storage devices and the second subset of storage devices to the second initiator.

In another exemplary embodiment, the communication fabric comprises at least one serially attached SCSI expander having a SCSI enclosure services processor, and wherein the computing device is the SCSI enclosure services processor. In a further exemplary embodiment, performing a health check comprises determining whether an initiator fails to interrogate the SCSI enclosure services processor within a preset time. In a still further exemplary embodiment, zoning a communication fabric comprises reading, by the SCSI enclosure services processor, a memory element to obtain the default zone configuration.

In yet another exemplary embodiment, the computing device is an initiator and the computer readable program is a SCSI management protocol function.

In another illustrative embodiment, an apparatus for dynamic communication fabric zoning comprises a communication device in a communication fabric. The communication fabric comprises a plurality of initiators and a plurality of storage devices. The apparatus further comprises a zoning component that zones the communication device according to a default zone configuration to zone at least one subset of the plurality of initiators to at least one subset of the plurality of storage devices. The apparatus further comprises a health check component that performs a health check. The zoning component rezones the communication device responsive to an initiator within the plurality of initiators failing the health check.

In one exemplary embodiment, the default zone configuration zones a first subset of the plurality of storage devices to a first initiator within the plurality of initiators and zones a second subset of the plurality of storage devices to a second initiator within the plurality of initiators. In a further exemplary embodiment, the first initiator fails the health check and rezoning the communication device comprises zoning the first subset of storage devices and the second subset of storage devices to the second initiator.

In another exemplary embodiment, the communication device is a serially attached SCSI expander. In a further exemplary embodiment, the zoning component is a SCSI enclosure services processor. In a still further exemplary embodiment, the SCSI enclosure services processor is coupled to a memory element and zoning the communication device comprises reading, by the SCSI enclosure services processor, the memory element to obtain the default zone configuration. In a further exemplary embodiment, performing a health check comprises determining whether an initiator fails to interrogate the SCSI enclosure services processor within a preset time.

In yet another exemplary embodiment, each storage device within the plurality of storage devices is a dual ported storage device.

In a further illustrative embodiment, a method for dynamic zoning of a communication fabric is provided. The communication fabric comprises a plurality of initiators and a plurality of storage devices. The method comprising zoning a communication fabric according to a default zone configuration to zone at least one of the plurality of initiators to at least one subset of the plurality of storage devices. The method further comprises performing a health check and responsive to an initiator failing the health check, rezoning the communication fabric.

In one exemplary embodiment, the default zone configuration zones a first subset of storage devices to a first initiator and zones a second subset of storage devices to a second initiator. In a further exemplary embodiment, the first initiator fails the health check and rezoning the communication fabric comprises zoning the first subset of storage devices and the second subset of storage devices to the second initiator.

In another exemplary embodiment, the communication fabric comprises at least one serially attached SCSI expander having a SCSI enclosure services processor. Performing a health check comprises determining whether an initiator fails to interrogate the SCSI enclosure services processor within a preset time. In a still further exemplary embodiment, zoning a communication fabric comprises reading, by the SCSI enclosure services processor, a memory element to obtain the default zone configuration.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A depicts a serially attached SCSI storage area network in which exemplary aspects of the illustrative embodiments may be implemented;

FIG. 1B illustrates the storage area network in a default zoning configuration in accordance with an exemplary embodiment;

FIG. 1C illustrates the storage area network in a rezoned configuration in accordance with an exemplary embodiment; and

FIG. 2 is a flowchart illustrating operation of a dynamic zoning mechanism in accordance with an illustrative embodiment.

### DETAILED DESCRIPTION OF THE ILLUSTRATIVE EMBODIMENTS

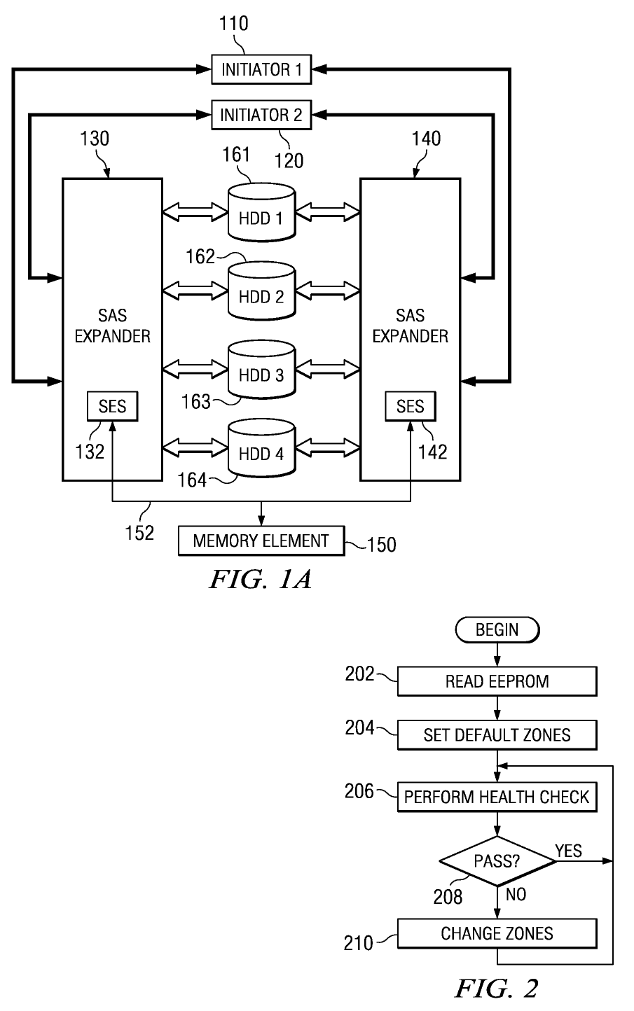

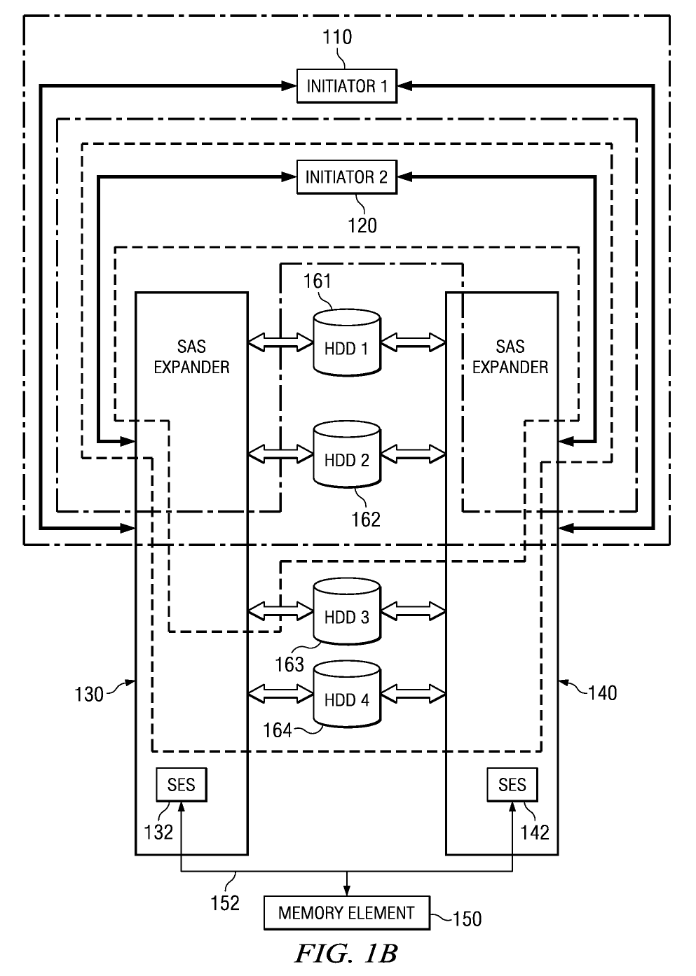

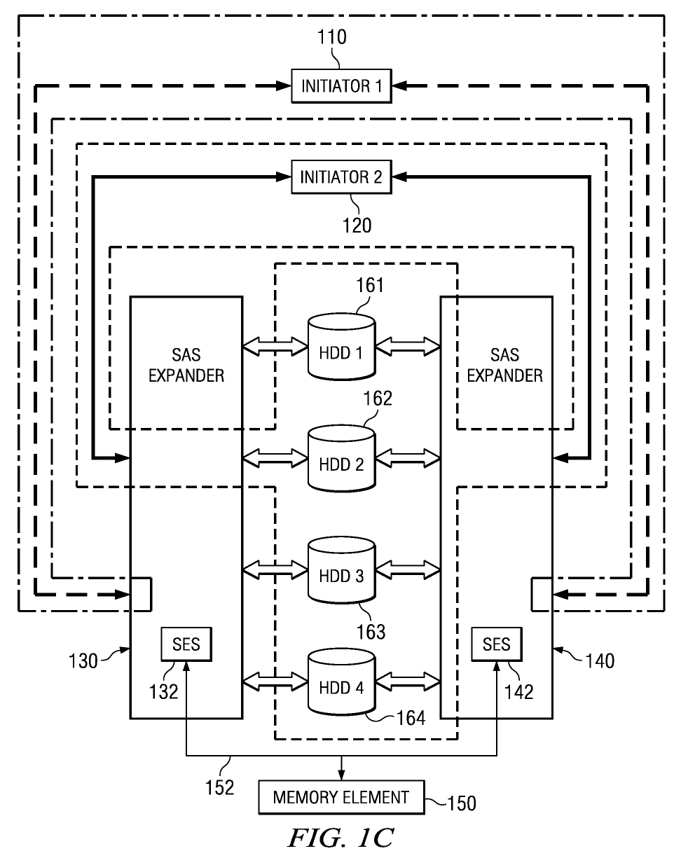

With reference now to the figures and in particular with reference to FIGS. 1A-1C, exemplary diagrams of data processing environments are provided in which illustrative embodiments of the present invention may be implemented. It should be appreciated that FIGS. 1A-1C are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIGS. 1A-1C are block diagrams illustrating a storage area network in which aspects of the illustrative embodiments may be implemented. More particularly, FIG. 1A depicts a serially attached SCSI (SAS) storage area network (SAN) in which exemplary aspects of the illustrative embodiments may be implemented. SAS expander 130 and SAS expander 140 are connected to dual ported hard disk drives (HDDs) 161-164. Initiator 1 110 is connected to SAS expander 130 and SAS expander 140. Similarly, initiator 2 120 is connected to SAS expander 130 and SAS expander 140. Each initiator has a connection to each port of HDDs 161-164 through SAS expanders 130, 140.

SAS expander 130 includes an on-chip SCSI enclosure services (SES) processor 132, which is used to create and manage zoning. Similarly, SAS expander 140 includes SES processor 142. One example of a family of expander products is the NexSAS™ family of products from Vitesse Semiconductor. Alternatively, a SCSI management protocol (SMP) function, which may run on initiators 110, 120 could also be involved in zoning.

In the depicted example, SES processors 132, 142 are connected together using bus 152 for communication. Bus 152 may be, for example, an inter-integrated circuit (IIC or I2C) bus. Memory element 150 also connects to bus 152. Memory element 150 may be a non-volatile memory, such as an electrically erasable programmable read only memory (EEPROM), for example.

Operating system and functional code in initiators 110, 120 may be limited in that they cannot see both ports of HDDs 161-164 at the same time. Therefore, the SAN must be zoned such that each initiator sees drives through only one port.

SES processor 132 and SES processor 142 read memory element 150 during boot time to determine the default zoning configuration. FIG. 1B illustrates the storage area network in a default zoning configuration in accordance with an exemplary embodiment. For demonstration purposes, this example assumes that the default configuration is for HDD 1 161 and HDD 2 162 are zoned to initiator 1 110 and HDD 3 163 and HDD 4 164 are zoned to initiator 2 120. Memory element 150 can be updated at any time to modify the default zoning configuration.

Periodically, initiators 110, 120 request diagnostic information from SES processors 132, 142 as part of normal operation, often referred to as a health check. If the SES processors are not interrogated by a given initiator within a preset time, the SES processors may assume that the given initiator has failed. As an example, a reasonable value for the preset time may be on the order of 10 seconds, although this value may be modified depending upon the implementation and other factors. If an initiator fails this health check by not interrogating SES processors 132, 142 within the preset time period, SES processors 132, 142 initiate rezoning the HDDs 161-164 to the initiator(s) that are still performing the health check successfully.

FIG. 1C illustrates the storage area network in a rezoned configuration in accordance with an exemplary embodiment. With an initiator fault detected for initiator 1 110, SES processors 132, 142 rezone SAS expanders 130, 140 to include all the HDDs 161-164 in the zone with initiator 2 120, which is still functional.

Those of ordinary skill in the art will appreciate that the hardware in FIGS. 1A-1C may vary depending on the implementation. Other hardware may be used in addition to or in place of the hardware depicted in FIGS. 1A-1C. Initiators 110, 120 may be embodied within data processing systems that may take the form of any of a number of different data processing systems including client computing devices, server computing devices, or the like.

FIG. 2 is a flowchart illustrating operation of a dynamic zoning mechanism in accordance with an illustrative embodiment. The dynamic zoning mechanism may be embodied within SCSI enclosure services (SES) processor 132 and/or SES processor 142 in FIGS. 1A-1C, for example. However, the dynamic zoning mechanism may exist elsewhere in the storage area network. For example, the dynamic zoning mechanism may be embodied within a SCSI management protocol (SMP) function that may run on initiators 110, 120 in FIGS. 1A-1C.

It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

Furthermore, the flowchart is provided to demonstrate the operations performed within the illustrative embodiments. The flowchart is not meant to state or imply limitations with regard to the specific operations or, more particularly, the order of the operations. The operations of the flowchart may be modified to suit a particular implementation without departing from the spirit and scope of the present invention.

With reference now to FIG. 2, operation begins, and the SES processors of SAS expanders with SAS zoning read a memory element to obtain default zones (block 202). The memory element may be an electrically erasable programmable read only memory (EEPROM), for example. In one exemplary embodiment, the SES processors may read the memory element using a bus, such as an I2C bus. Given the default zones, the SAS expanders set the default zones (block 204).

Next, the system performs a health check (block 206). In one exemplary embodiment, when the system performs a health check, the initiators request diagnostic information from the SES processors. The mechanism determines whether the system passes the health check (block 208). In the examples depicted in FIGS. 1A-1C, if the SES processors are not interrogated by a particular initiator within a preset time period, a SES processor may determine that the initiator has failed.

If the system passes the health check, operation returns to block 206 to repeat the health check. If the mechanism determines that the system has failed the health check in block 208, the SES processors rezone the expanders (block 210). Thereafter, operation returns to block 206 to repeat the health check.

Although not depicted in FIG. 2, if a new initiator begins communication with the SES processors, or an initiator reestablishes communication with the SES processors as part of normal operation, this will be detected during the health check in block 206. Therefore, the SES processors may rezone the processors, as in block 210, to include the new initiator.

Thus, the illustrative embodiments resolve the disadvantages of the prior art by providing a mechanism for dynamically zoning or rezoning serially attached SCSI expanders using an intelligent failover mechanism. The mechanism uses serially attached SCSI (SAS) zoning by zoning off one port of the SAS hard disk drive to the initiator that does not “own” the resource. The drive will appear to only one initiator as a result of the zoning. In the event of a failure on the “owning” initiator, the failover mechanism may change the zones, zoning off the failed initiator and including the drives in the zone(s) of the active initiator(s). By using zoning in this fashion, the zoning mechanism creates an active-passive SAS multiplexer with configurable and intelligent failover.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
zone a communication fabric comprising a plurality of initiators and a plurality of storage devices according to a default zone configuration to zone at least one of the plurality of initiators to at least one subset of the plurality of storage devices;
perform a health check; and
responsive to an initiator failing the health check, rezone the communication fabric.

2. The computer program product of claim 1, wherein the default zone configuration zones a first subset of storage devices to a first initiator and zones a second subset of storage devices to a second initiator.

3. The computer program product of claim 2, wherein the first initiator fails the health check and wherein rezoning the communication fabric comprises zoning the first subset of storage devices and the second subset of storage devices to the second initiator.

4. The computer program product of claim 1, wherein the communication fabric comprises at least one serially attached SCSI expander having a SCSI enclosure services processor, and wherein the computing device is the SCSI enclosure services processor.

5. The computer program product of claim 4, wherein performing the health check comprises:
determining whether an initiator fails to interrogate the SCSI enclosure services processor within a preset time.

6. The computer program product of claim 4, wherein zoning the communication fabric comprises:
reading, by the SCSI enclosure services processor, a memory element to obtain the default zone configuration.

7. The computer program product of claim 1, wherein the computing device is an initiator, and wherein the computer readable program is a SCSI management protocol function.

8. An apparatus for dynamic communication fabric zoning, comprising:
a communication device in a communication fabric, wherein the communication fabric comprises a plurality of initiators and a plurality of storage devices;
a zoning component that zones the communication device according to a default zone configuration to zone at least one subset of the plurality of initiators to at least one subset of the plurality of storage devices; and
a health check component that performs a health check, wherein the zoning component rezones the communication device responsive to an initiator within the plurality of initiators failing the health check.

9. The apparatus of claim 8, wherein the default zone configuration zones a first subset of the plurality of storage devices to a first initiator within the plurality of initiators and zones a second subset of the plurality of storage devices to a second initiator within the plurality of initiators.

10. The apparatus of claim 9, wherein the first initiator fails the health check and wherein rezoning the communication device comprises zoning the first subset of storage devices and the second subset of storage devices to the second initiator.

11. The apparatus of claim 8, wherein the communication device is a serially attached SCSI expander.

12. The apparatus of claim 11, wherein the zoning component is a SCSI enclosure services processor.

13. The apparatus of claim 12, wherein the SCSI enclosure services processor is coupled to a memory element, wherein zoning the communication device comprises:
reading, by the SCSI enclosure services processor, the memory element to obtain the default zone configuration.

14. The apparatus of claim 11, wherein performing the health check comprises:
determining whether an initiator fails to interrogate the SCSI enclosure services processor within a preset time.

15. The apparatus of claim 8, wherein each storage device within the plurality of storage devices is a dual ported storage device.

16. A method for dynamic zoning of a communication fabric, wherein the communication fabric comprises a plurality of initiators and a plurality of storage devices, the method comprising:
zoning a communication fabric according to a default zone configuration to zone at least one of the plurality of initiators to at least one subset of the plurality of storage devices;
performing a health check; and
responsive to an initiator failing the health check, rezoning the communication fabric.

17. The method of claim 16, wherein the default zone configuration zones a first subset of storage devices to a first initiator and zones a second subset of storage devices to a second initiator.

18. The method of claim 17, wherein the first initiator fails the health check and wherein rezoning the communication fabric comprises zoning the first subset of storage devices and the second subset of storage devices to the second initiator.

19. The method of claim 16, wherein the communication fabric comprises at least one serially attached SCSI expander having a SCSI enclosure services processor, wherein performing a health check comprises:
determining whether an initiator fails to interrogate the SCSI enclosure services processor within a preset time.

20. The method of claim 19, wherein zoning the communication fabric comprises:
reading, by the SCSI enclosure services processor, a memory element to obtain the default zone configuration.
